(19) United States
(12) Patent Application Publication
(10) Pub. No.: US 2005/0017949 A1
(43) Pub. Date: Jan. 27, 2005

(54) Multiple electronic display remote control

(76) Inventors: Daniel Dunn, Los Gatos, CA (US); Nike Mikes, Los Gatos, CA (US)

Correspondence Address: NIKE MIKES, 20711 BEAR CREEK RD, LOS GATOS, CA, 95033, US

(21) Appl. No.: 10/625,088

(22) Filed: Jul. 22, 2003

(51) Int. Cl. G09G 5/08

(52) U.S. Cl. 345/158

(57) ABSTRACT

A remote control providing the means for making adjustments to a plurality of electronic display screens. The remote control provides the means to control a selected group or groups from the array of electronic displays or of the entire array of multiple electronic display screens. The commands being sent would include but are not limited to brightness up and down, contrast up and down, input source, color intensity, aspect ratio, ‘on/off’ features and other commands or adjustments applicable to an array of multiple electronic displays. The adjustments can be made simultaneously or in a desired sequence. The remote control transmits information via infra-red, radio frequency or other wireless means to a remote sensor with a microprocessor located within the electronic display or to a central microprocessor that serves to further the signal to each electronic display.

### CLAIM OF PRIORITY

The present application claims priority to U.S. Provisional Patent Application Ser. No. 60/306,510 filed on Jul. 22, 2002.

### BACKGROUND OF THE INVENTION

1. Field of the Invention

The present invention relates generally to an improved user interface for a plurality of electronic displays as well as associated devices via a remote control.

2. Background

As computing applications have become more sophisticated, the ability to utilize multiple displays provides users with increased productivity and capabilities in manipulating such applications. Such multiple display systems are becoming more popular as the cost of such systems decreases, while the imaging and processing capability of today's image-based computers continue to rise. Faster computing power, multi-tasking between applications, multi-media applications and the integration of Internet-based communications and resources all drive the desire to utilize multi-display systems. Typically, the benefits of multiple monitor computing are seen in specialized financial and graphics computer applications. However, multiple display computing is also increasing among the general computing public and so the need to easily and efficiently adjust multiple electronic displays is growing. There is also a wide range of ‘video wall’ style applications wherein a plurality of electronic displays are used to show data, images, etc. on multiple screens for viewing by one or more individuals. These applications include mission critical monitoring scenarios, commercial dynamic displays in multiple screen arrays as well as information systems where content can be allocated per screen, across a selected grouping or across all screens. In the case of video wall type applications the electronic displays may be in remote or difficult to access locations.

To turn screens on and off and to adjust screen features such as brightness and contrast, currently the user must adjust each screen individually. Typically adjustments can be made using a push button interface located on each screen. These types of adjustments can also on occasion be made utilizing the keyboard as the interface. In both instances each screen must be adjusted individually, a process that is time consuming as well as making consistent overall adjustment to an array of multiple electronic displays difficult and inefficient.

3. Related Art

Some computer manufacturers such as Gateway, in 1996, provide a remote control for computer related functions but do not control multiple electronic flat panel displays. Another related invention is described in U.S. Pat. No. 6,313,851 to Matthews, III, et al. This remote interface is said to enable a user to fully navigate and operate a computer through the use of a remote control device, the present invention includes at least a PC mode of operation and a theater mode of operation, wherein the theater mode is designed for distance use with the remote device.

U.S. Pat. No. 5,532,719 to Kikinis provides for the means of controlling single CRT screen settings but again not a plurality of screens while it also limits itself to CRT screen technology.

To date remote control solutions for CRTs, flat panel displays or other electronic displays have not addressed the need of multiple monitor applications and users to provide an efficient and user-friendly manner by which to adjust and optimize multiple electronic display arrays.

### SUMMARY OF THE INVENTION

The present invention, roughly described, pertains to a remote control for arrays of multiple electronic display screens. This remote control gives the user the ability to easily and efficiently control a desired selection or grouping or of all electronic displays in an array of unlimited quantity. In addition to typical screen adjustment such as brightness and contrast the invention enables the user to turn screens off and on as well as directing the input devices, including but not limited to those interfacing with S-Video, i.e.: DVD players and satellite TV and those interfacing with RCA, i.e.: VCRs and video game players. The remote control is also capable of controlling additional peripherals and electronic devices such as speakers.

This remote control provides for greater efficiency over single electronic display controls in an array of a plurality of screens since screens do not have to be adjusted one by one and so additionally provides for greater consistency among adjustments. The remote control also enhances energy efficiency since screens can be powered off or down instantly. And the remote control improves ease of use when managing multiple electronic displays since there is no need to manually depress control buttons.

### DESCRIPTION OF THE DRAWINGS

The invention will be described with respect to the particular embodiments thereof. Other objects, features and advantages of the invention will become apparent with reference to the specification and drawing in which:

FIG. 1 shows a diagram of a plurality of three electronic displays controlled remotely via a central microprocessor and hand held remote control device.

FIG. 2 shows a diagram of a plurality three electronic displays controlled remotely via multiple microprocessor built into the displays and hand held remote control device.

FIG. 3 shows a diagram of three electronic displays controlled remotely with each electronic display flat panel screen having the means to electronically or mechanically provide the display with a unique identity code.

### WRITTEN DESCRIPTION

### Detailed description

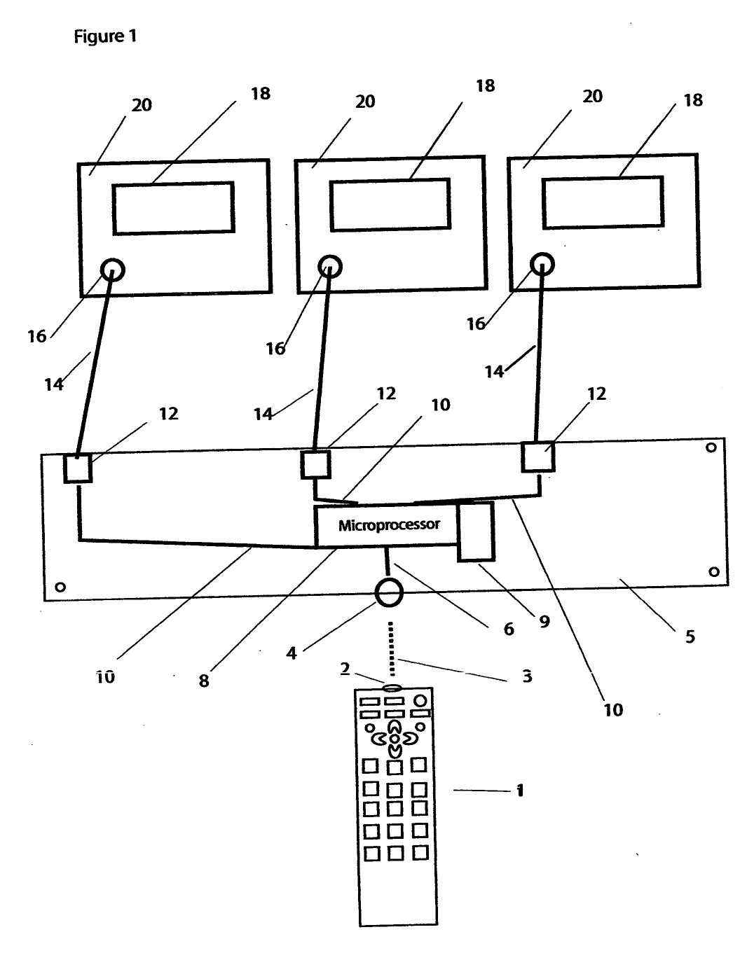

In the preferred embodiment of FIG. 1, the remote control 1 transmits signals via infra red, radio frequency or other means of wireless transmission 3 to a receiver box 5. The information being transmitted by the transmitter 2 is received by the receiver 4. This receiver is connected to the microprocessor by means of a cable or copper trace of a printed circuit board and can be located in the receiver box 5 or located remotely. The remote control has the ability to transmit a code that can be interpreted by the microprocessor 8 as a command to send a set of instructions to a single electronic display a designated plurality of electronic displays in an array or all displays in the array either in a particular sequence or simultaneously.

To achieve this, the user might depress a button or a combination of buttons on the remote control 1 keypad. This command is transmitted to the microprocessor 8. The microprocessor 8 is programmed to have the means to determine the instruction to follow the particular command and to send either the raw information being sent to the microprocessor 8 directly to a specific electronic display panel 20 or to send a different information set stored in memory 9. Information sent to the electronic display 20 is sent from the processor 8 is sent to the electronic display 20 by means of either wire or wireless means 10, 12, 14 and is received by the input connector or electronic sensor 16 of the electronic display 20. Each electronic display 20 has the means to receive the information received through the signal receiver 16 and to carry out the commands by means of pre-programmed hardware and software built into the electronic display.

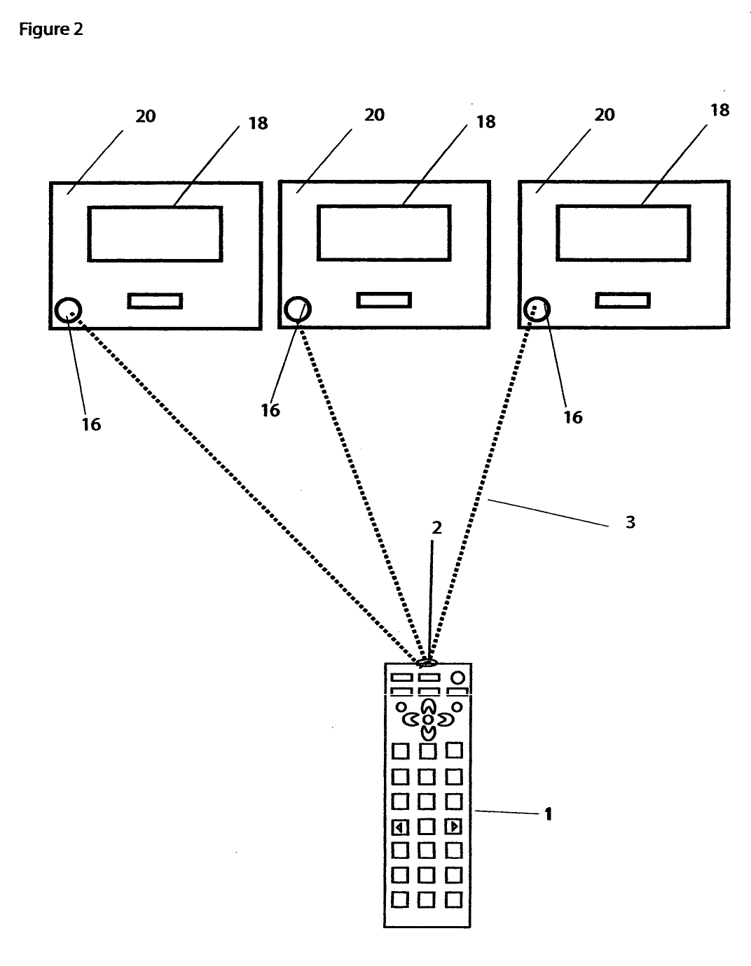

In an alternative embodiment, FIG. 2, by pressing keys on the remote control 1, the user can send information directly to the electronic display 20. This is achieved by means of a remote control sensor located at each electronic display 20. By means of synchronizing command information at the remote control and the electronic display 20 each display can be programmed to have a specific identification number or code. This enables the user to send commands to a plurality of electronic displays 20 which would trigger single, groups, or all displays to execute the commands being transmitted by the remote control 1.

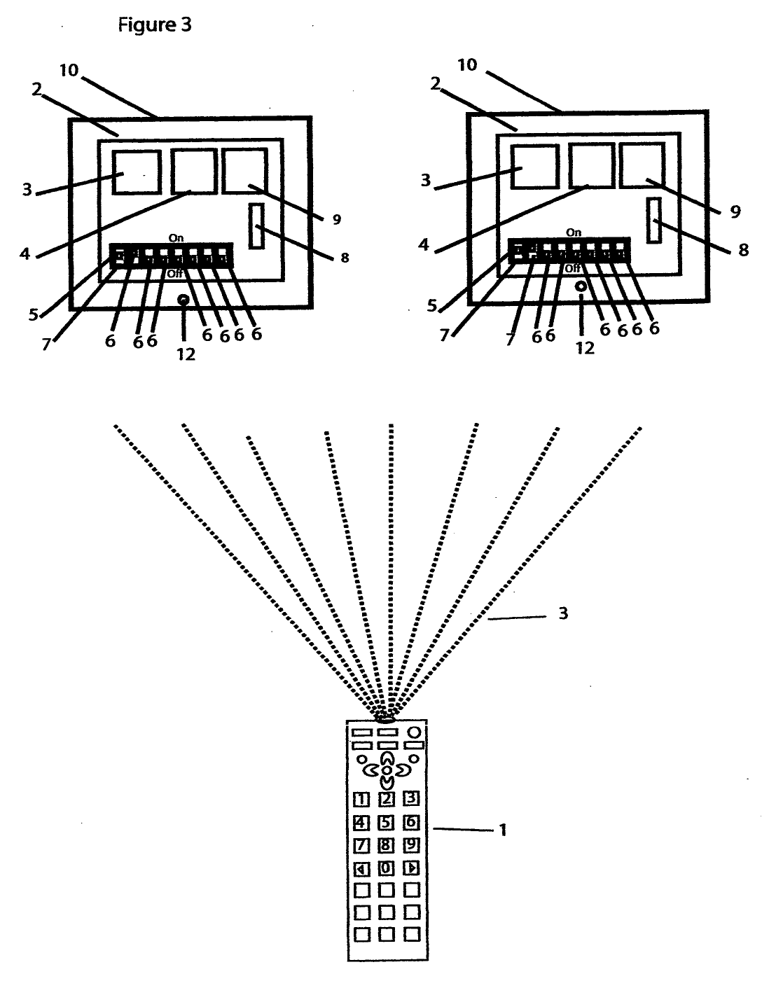

In a further embodiment, FIG. 3, the remote control 1 transmits information via infra-red, radio frequency or other wireless means to the remote sensor 8 of the electronic display 8. The information received is sent to the remote command microprocessor 9. Incorporated into the display is the means to electronically or mechanically provide the display with a unique identity code, such as a switch block 5 or other code encoding mechanism. Additional means of encoding information into each screen would include but are not limited to dials, buttons, switches, and other mechanical means. Unique identity means would also include software or other non-mechanical means. Once the unique identity is inputted, the microprocessor is able to determine whether or not to act upon the commands being received by the electronic display 10. Once a unique identity has been programmed into each display the user can send commands to any single electronic displays or to pre-established groups or to all displays. The commands being sent would include but are not limited to brightness up and down, contrast up and down, input source, color intensity and other commands or adjustments applicable to electronic displays devices.

1) A multi-electronic display remote control apparatus, comprising:
A transmitter to send wired or wireless code to two or more receivers
A signal receiver having the capability of receiving wired or wireless signals from the signal transmitter and the ability to route received signals to a plurality of electronic displays.
A plurality of electronic displays with the means of receiving and interpreting code delivered by wired or wireless means.

2) The multi-electronic-display remote-control of claim 1 wherein the said transmitter comprises an infra-red transmitter.

3) The multi-electronic-display remote-control of claim 1 wherein the said transmitter comprises a radio frequency transmitter.

4) The multi-electronic-display remote-control of claim 1 wherein the said transmitter comprises a wired signal-transmission apparatus.

5) ) The multi-electronic-display remote-control of claim 1 wherein the said transmitter comprises code capable of transmitting instructions to the receiver for indicating electronic display selection and instructional commands.

6) The multi-electronic-display remote-control of claim 1 wherein the said signal receiver having a means of wired or wireless signal input.

7) The multi-electronic-display remote-control of claim 1 wherein the said signal receiver having a means of decoding received signals.

8) The multi-electronic-display remote-control of claim 1 wherein the said signal receiver having a means of decoding command code transmitted by said signal transmitter.

9) The multi-electronic-display remote-control of claim 1 wherein the said signal receiver having a means of transmitting decoded commands from the said signal transmitter.

10) The multi-electronic-display remote-control of claim 1 wherein the said signal receiver having a plurality of wired or wireless signal outputs.

11) The multi-electronic-display remote-control of claim I wherein the said signal receiver having a means of transmitting command code received from said signal transmitter to one or more of the signal outputs.

12) The multi-electronic-display remote-control of claim 1 wherein the said electronic display having the means to receive the wireless or wired electronic code transmitted the signal receiver.

13) The multi-electronic-display remote-control of claim 1 wherein the said electronic display having the means to receive the wireless or wired electronic code transmitted by the wired or wireless transmitter.

14) A multi-electronic display remote control apparatus, comprising:
A transmitter to send wired or wireless code to two or more receivers
An electronic display with the means of mechanically or electronically being assigned a unique identity code for receiving and interpreting said user setting and commands transmitted by said transmitter.

15) The multi-electronic-display remote-control of claim 14 wherein the said transmitter comprises an infra-red transmitter.

16) The multi-electronic-display remote-control of claim 14 wherein the said transmitter comprises a radio frequency transmitter.

17) The multi-electronic-display remote-control of claim 14 wherein the said transmitter comprises a wired signal-transmission apparatus.

18) The multi-electronic-display remote-control of claim 14 wherein the said transmitter comprises code capable of transmitting instructions to the receiver for indicating electronic display selection and instructional commands.

19) The multi-electronic-display remote-control of claim 14 wherein the said electronic display can be given a unique identification number or code.

20) The multi-electronic-display remote-control of claim 14 wherein the said electronic display can selectively execute or not execute code being received from the transmitter based on the identification ID being sent and the ID assigned to the said electronic display.

22) The multi-electronic-display remote-control of claim 14 wherein the said electronic incorporates an apparatus which incorporates a mechanical means including, but not limited to, a series of switches, rotary switch, or other mechanical means for setting a unique identity to the said electronic display.

23) The multi-electronic-display remote-control of claim 14 wherein the said electronic display incorporates electronic means for assigning a permanent unique signal receiver ID.

24) The multi-electronic-display remote-control of claim 14 wherein the said electronic display incorporates electronic means for assigning and changing the unique signal receiver ID.

25) The multi-electronic-display remote-control of claim 14 wherein the said electronic display incorporates electronic means for mechanically assigning and changing a unique signal receiver ID.

26) The multi-electronic-display remote-control of claim 14 wherein the said unique ID to the electronic display can be changed by the user or permanently set by the factory at the time of manufacture.

27) The multi-electronic-display remote-control of claim 14 wherein the said electronic display apparatus incorporated into to a multi-screen system has the means to receive command signals or code from a wired or wireless transmitter..

28) The multi-electronic-display remote-control of claim 14 wherein the said electronic display apparatus incorporated into to a multi-screen system has the means to receive command signals or code from a wired or wireless transmitter..

29) The multi-electronic-display remote-control of claim 14 wherein the said electronic display apparatus an apparatus to be incorporated into or connected to an electronic display has the means to receive command signals or code from a wired or wireless transmitter and translate the received code into new code to be sent to the electronic display.

30) Electronic display remote control receiver comprising:
An input port for receiving electronic code from a wired or wireless transmitting device.
A CPU having the means of decoding information received by the input port and sending said decoded information to an electronic display.
Electronic memory for operational and user defined functions.
The means for generating a unique identity code or setting to the fore-mentioned.
An electronic output port for connecting to an electronic display.

31. An electronic display having the means of selectively processing user input commands based on a unique ID set within said electronic display.

32. The means for electronically assigning a unique electronic identity code to an electronic display wherein said code would allow the said remote control user to selectively control said electronic display or display.

33. the means for mechanically assigning a unique electronic identity code to an electronic display wherein said unique identity code would allow the user to selectively send commands for making user adjustments to said electronic display.

34. The remote control of a plurality of electronic display screens as in claim 1 where in the display characteristics possible to adjust include but are not limited to brightness, contrast, on/off and other screen commands.

35. The remote control of a plurality of electronic display screens as in claim 1 wherein the display characteristics possible to adjust can be made to a selected group or groups in the array or to the entire array.

36. The remote control of a plurality of electronic display screens as in claim 1 wherein the display characteristics possible to adjust can be made simultaneously or in a desired sequence.

37. An electronic display having the means of being assigned by mechanical or electronic means a unique electronic identity code for selectively processing user command codes being generated by a wired or wireless transmission apparatus.

38. The electronic display of claim 37 wherein the said mechanical means for setting a unique code could include a series of switches.

39. The electronic display of claim 37 wherein the said mechanical means for setting a unique code could include a rotary switch.

40. The electronic display of claim 37 wherein the said electronic means for setting a unique code includes a electronic buttons.

41. The electronic display of claim 37 wherein the said electronic means for setting a unique code includes electronic code integrated into the electronic display.

42. The electronic display of claim 37 wherein the said electronic means includes a series of commands entered through a user interface such as those commonly found on the front of an LCD display.
